(19) United States
(12) Patent Application Publication
(10) Pub. No.: US 2025/0172794 A1
(43) Pub. Date: May 29, 2025

(54) A PORTABLE DIGITAL NIGHTVISION DEVICE WITH EXTENDED DYNAMIC RANGE AND METHOD USING THE SAME

(71) Applicant: UAB "YUKON ADVANCED OPTICS WORLDWIDE", Vilnius (LT)

(72) Inventor: Aliaksandr ALSHEUSKI, Vilnius (LT)

(21) Appl. No.: 18/839,299

(22) PCT Filed: Feb. 18, 2022
(86) PCT No.: PCT/IB2022/051458

§ 371 Date: Aug. 16, 2024

(51) Int. Cl. G02B 23/12; H04N 23/56; H04N 23/73; H04N 23/74; H04N 23/741

(52) U.S. Cl. CPC G02B 23/12; H04N 23/56; H04N 23/73; H04N 23/74; H04N 23/741

(57) ABSTRACT

This disclosure relates to the digital nightvision devices, in particular portable digital nightvision device with extended dynamic range and method using the same. The portable digital nightvision device at least includes comprises: objective lens, an image sensor, an image processing unit, an electronic display, a battery, an eyepiece, wherein the image processing unit further includes comprises an extended dynamic range module which is configured to combine the first digital video frame and the second digital video frame to obtain an extended dynamic range frame of the current scene wherein the first frame captures the details of the foreground image scene with longer exposure, and the second frame captures the details of the background image scene with shorter exposure.

### FIELD OF THE INVENTION

This disclosure relates to the digital nightvision devices, in particular to portable digital nightvision device with extended dynamic range and method using the same.

### BACKGROUND ART

The night vision systems have important role in the military application but also in civilian surveillance systems. There are currently a number of technologies used in night vision equipment. Traditional night vision devices use optoelectronic image enhancement, which works by sensing small amounts of infrared light that are reflected off objects and then electrically amplifying that light into a characteristic glowing green image. A newer technology, digital image enhancement, captures available light on a digital image sensor and then digitally enhances the images in a display.

Most night vision devices today employ a digital version of traditional optoelectronic image enhancement technology. Digital image enhancement technology results in more versatile night vision devices. With digital night vision, the light entering the objective lens is converted into a digital signal via, for example, a metal-oxide-semiconductor (CMOS) sensor, like the ones used in digital video cameras. The digital image is enhanced electronically and then sent to a display, for example an LCD screen, for viewing. In addition to direct viewing via the LCD screen, many digital night vision devices can be connected to other devices, such as still or video cameras, for remote viewing. Digital night vision signals can also be stored digitally, on SD cards, USB drives, or other storage devices. Some digital night vision devices feature Wi-Fi capability for easy sharing and live-streaming of videos and images to smartphones, computers, and other devices.

However, in digital night vision devices with infrared illumination, the illumination reflected from the foreground images will be much higher in power than illumination from the objects that are further away, thus the objects that are in the background image won't be captured properly and won't be seen by the human in the digital night vision device.

The problem that the most common scenes have some objects that are closer to the camera and those that are further away. Infrared illumination reflected from the objects that are closer to the camera will be somehow stronger than illumination reflected from the further away objects. In these circumstances, a captured frame from a focal plane array, will provide a satisfactory image only of the foreground objects or background objects, but never both.

The level of illumination that is adequate for the foreground images will be not enough to obtain the good images from the background images, or, if the level of illumination is good enough to illuminate background objects, it will be excessive for foreground objects to make them “bleached out”.

In the present invention, the above stated technical problem is solved by implementing an extended dynamic range into a portable digital nightvision device. It is implemented by generating at least two video frames with different level of exposure combining them into real-time one extended dynamic range video frame. The first video frame is captured at the short exposure level to capture objects in the foreground image and the second video is captured at the longer exposure level to capture objects in the background image. The final result is the sequence of the extended dynamic range video frames that allows clearly to see the objects in foreground and background. For example, using this method in digital nightvision riflescope allows clearly see the target in dark or low light environments.

### SUMMARY OF THE INVENTION

The present invention discloses a portable digital nightvision device with extended dynamic range and method using the same. The portable digital nightvision device comprises: objective lens, an image sensor, an image processing unit, an electronic display, a battery, an eyepiece, wherein the image processing unit further comprises an extended dynamic range module. The image sensor is configured to capture at least two simultaneous digital video frames at different exposure. The image processing unit is configured to generate a first digital video frame at first exposure level, simultaneously generating a second digital video frame at second exposure level. The extended dynamic range module is configured to combine the first digital video frame and the second digital video frame to obtain an extended dynamic range frame of the current scene, wherein the first frame captures the details of the foreground image scene with longer exposure, and the second frame captures the details of the background image scene with shorter exposure. The electronic display is configured to deliver at least one extended dynamic range digital video frame. The portable digital nightvision device further comprises an infrared (IR) illuminator and a digital reticle.

A method using a portable digital nightvision device with extended dynamic range for capturing extended dynamic range video frames, comprises the following steps: capturing, by an image sensor at least two simultaneous digital video frames at different exposure; generating, by an image processing unit, a first digital video frame at first exposure level, simultaneously generating a second digital video frame at second exposure level; combining, by an extended dynamic range module, the first digital video frame and the second digital video frame to obtain an extended dynamic range frame of the current scene; delivering, by an electronic display, at least one extended dynamic range digital video frame. The first frame captures the details of the foreground image scene with the longer exposure. The second frame captures details of the background image scene with the shorter exposure.

The main result is the sequence of the extended dynamic range video frames that allows to capture details in a full range of the image in dark or low light conditions.

### BRIEF DESCRIPTION OF THE DRAWINGS

FIG. 1. is a graphical representation of the digital nightvision device with extended dynamic range; and

FIG. 2. is a flowchart illustrating a method of using extended dynamic range in portable digital nightvision device.

### DETAILED DESCRIPTION OF THE INVENTION

The following detailed description discloses a portable digital nightvision device with extended dynamic range and method using the portable digital nightvision device for capturing extended dynamic range video frames. The term “portable digital nightvision device” includes, but not limits to, digital nightvision riflescopes, digital nightvision monoculars, and other digital optical devices. The term “Extended Dynamic Range” may also refer to High Dynamic Range (HDR) or Wide Dynamic Range (WDR).

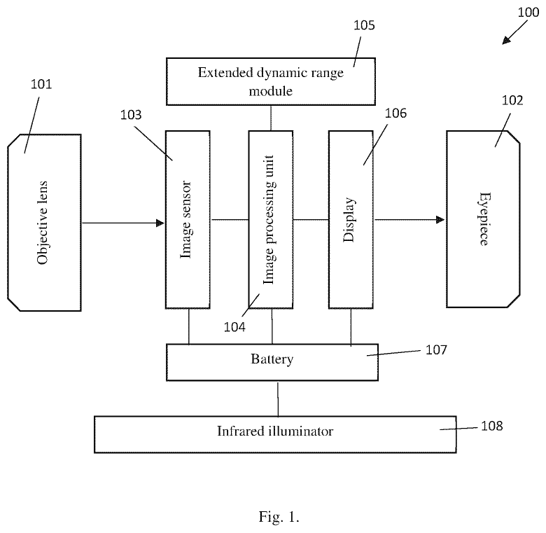

FIG. 1. is a graphical representation of the portable digital nightvision device with extended dynamic range. The portable digital nightvision device (100) at least comprises: objective lens (101), an image sensor (103), an image processing unit (104), an electronic display (106), a battery (107), an eyepiece (102), wherein the image processing unit (104) further comprises an extended dynamic range module (105).

The portable digital nightvision device (100) can further comprise an infrared (IR) illuminator (108), wherein the said IR illuminator (108) is used to enhance the performance of the portable digital nightvision device (100) in low-light conditions. The IR illuminator (108) can be either LED illuminator, or laser illuminator.

The objective lens (101) is configured to project images onto the surface of the image sensor (103), which in turn transforms reflections from the light of the object into an electric signal.

The image sensor (103) can be either a Charge-Couple device (CCD) sensor, or a metal-oxide-semiconductor (CMOS) sensor. The image sensor (103) is configured to capture the series of digital video frames at the different level of exposure. The exposure level of the frames can be varied by the shutter speed of the portable digital nightvision device (100). In the particular embodiment, the image sensor (103) is configured to capture at least two simultaneous digital video frames at different exposure.

The image processing unit (104) is configured to process the signal that is obtained from the image sensor (103) and further transmit the signal to the display (106) where the image of the observed object is shaped. In the particular embodiment, the image processing unit (104) is configured to generate a first digital video frame at first exposure level, simultaneously generating a second digital video frame at second exposure level. The image processing unit (104) comprises an extended dynamic range module (105) that is configured to combine the first digital video frame and the second digital video frame to obtain an extended dynamic range frame of the current scene, wherein the first frame captures the details of the foreground image scene with longer exposure, and the second frame captures the details of the background image scene with shorter exposure.

The electronic display (106) can comprise either LCD display (where the display is lit up from the back side), or OLED display (when electric current is applied its substance starts to emit light). The electronic display (106) is configured to deliver at least one extended dynamic range digital video frame.

A battery (107) is used to provide power to components and functions associated with the illustrated digital nightvision device (105). For example, the battery (107) can be used to power the image sensor (103), the image processing unit (104) or the electronic display (106). The battery (107) can include rechargeable/non-rechargeable batteries like lead-acid, nickel-cadmium (NiCd), nickel-metal hydride (NiMH), lithium-ion (Li-ion), lithium-ion polymer (Li-ion polymer), or other suitable battery technologies consistent with this disclosure. The rechargeable battery can be charged directly, using for example at least one USB and/or micro-USB port, located on the outer side of the optical device.

An eyepiece (102) is configured to pick up images of the generated sequence of extended dynamic range frames and bring them to the user's eye.

The portable digital nightvision device (100) is configured to permit mounting on equipment (for example, a firearm or tripod) using mounting systems similar to those used in mounting optical devices, for example, a ring-type mounting system.

The portable digital nightvision device (100) can further comprise a digital reticle, wherein the image of the reticle during the video signal processing is overlaid on the image on the electronic display (106) and moved electronically.

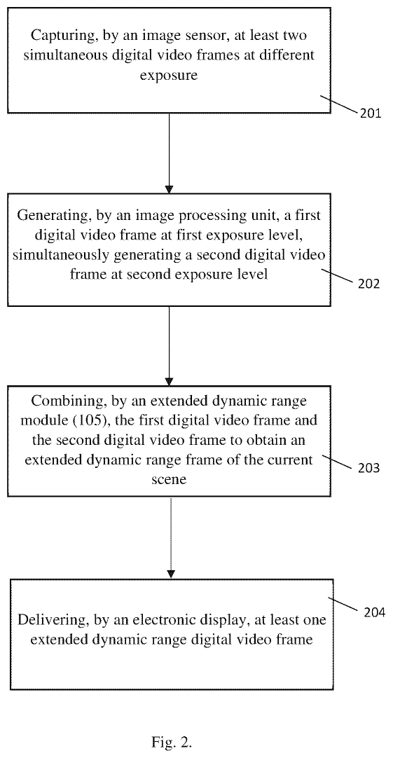

FIG. 2. is a flowchart illustrating a method of using the portable digital nightvision device (100) with extended dynamic range for capturing extended dynamic range video frames. The method comprises the following steps:
capturing, by an image sensor (103), at least two simultaneous digital video frames at different exposure (201);
generating, by an image processing unit (104), a first digital video frame at first exposure level, simultaneously generating a second digital video frame at second exposure level (202); fusing, by an extended dynamic range module (105), the first digital video frame and the second digital video frame to obtain an extended dynamic range frame of the current scene (203); delivering, by an electronic display (106), at least one extended dynamic range digital video frame (204).

The series (or sequence) of digital video frames are captured at the different level of exposure. The exposure level of the frames can be varied by the shutter speed of the portable digital nightvision device (100).

An extended dynamic range module (105), located in the image processing unit (104) of the portable digital nightvision device (100), converts the series of digital video frames into a series of extended dynamic range video frames. The extended dynamic range module (105) combines a plurality of frames from the series of digital video frames, captured by the image sensor (103) of the portable digital nightvision device (100), where each of the combined frames has a different exposure level, to generate an extended dynamic range video frame. By repeating the combination of digital video frames, a series of extended dynamic range video frames may be generated. At least two frames with different level of exposure are used to generate the extended dynamic range video frame. The first frame captures the details of the foreground image scene with the shorter exposure. The second frame captures details of the background image scene with the shorter exposure. Additional frames may also be used to generate the extended dynamic range frame. The extended dynamic range module (105) then combines two or more frames with different level of exposure from the series to generate the extended dynamic range frame. For example, a first digital video frame at a first exposure level is obtained by the extended dynamic range module (105) and delayed for one time period until the next digital frame at a different level of exposure is obtained by the extended dynamic range module (105). The optimal matching between objects in video frames may be determined using the methods such as, for example, the sum of absolute differences (SAD) which compare the absolute values of the pixels. The two images at different exposures are then combined to generate the extended dynamic range video frame using, for example, tone mapping or other appropriate contrast enhancement process. An example of tone mapping is to remove texture detail from the image and perform compression using an appropriate mapping (for example, S-curve mapping) and then adding the texture detail back in. In this way, local detail (or texture) is maintained while the overall dynamic range is reduced to match the capabilities of the display. Nonlinear filtering can be applied to segregate the texture details from the base, or illumination, layer of the image. The base layer is subjected to compression to map the large dynamic range down to a practical range while the details or texture layer undergoes only subtle changes. The two resulting layers are then combined to produce an extended dynamic range frame. The main result of the method presented above is the sequence of the extended dynamic range video frames.

This disclosure uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A portable digital nightvision device with extended dynamic range for capturing extended dynamic range video frames, comprising:
objective lens,
an image sensor,
an image processing unit,
an electronic display,
a battery,
an eyepiece,
wherein the image processing unit further comprises an extended dynamic range module.

2. The portable digital nightvision device according to claim 1, wherein the image sensor is configured to capture at least two simultaneous digital video frames at different exposure.

3. The portable digital nightvision device according to claim 1, wherein the image processing unit is configured to generate a first digital video frame at first exposure level, simultaneously generating a second digital video frame at second exposure level

4. The portable digital nightvision device according to claim 1, wherein the extended dynamic range module is configured to combine the first digital video frame and the second digital video frame to obtain an extended dynamic range frame of the current scene wherein the first frame captures the details of the foreground image scene with longer exposure, and the second frame captures the details of the background image scene with shorter exposure.

5. The portable digital nightvision device according to claim 1, wherein the electronic display is configured to deliver at least one extended dynamic range digital video frame.

6. The portable digital nightvision device according to claim 1, wherein said device further comprises an infrared (IR) illuminator.

7. The portable digital nightvision device according to claim 1, wherein said device further comprise a digital reticle

8. A method of using the portable digital nightvision device with extended dynamic range for capturing extended dynamic range video frames, the method comprising the following steps: capturing, by an image sensor, at least two simultaneous digital video frames at different exposure;
generating, by an image processing unit, a first digital video frame at first exposure level, simultaneously generating a second digital video frame at second exposure level;
combining, by an extended dynamic range module, the first digital video frame and the second digital video frame to obtain an extended dynamic range frame of the current scene; delivering, by an electronic display, at least one extended dynamic range digital video frame.

9. The method according to claim 5, wherein the first frame captures the details of the foreground image scene with the longer exposure.

10. The method according to claim 5, wherein the second frame captures details of the background image scene with the shorter exposure.
